(19) United States
(12) Patent Application Publication
(10) Pub. No.: US 2005/0091332 A1
(43) Pub. Date: Apr. 28, 2005

(54) Remote monitoring system

(75) Inventors: Eiji Moro, Hitachinaka (JP); Shigehisa Rokuta, Mito (JP); Kazuo Shigematsu, Yoshikawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/918,532

(22) Filed: Aug. 12, 2004

(30) Foreign Application Priority Data
Aug. 13, 2003 (JP) 2003-292780

(51) Int. Cl. G06F 15/16; H04Q 7/00

(52) U.S. Cl. 709/208; 370/328

(57) ABSTRACT

In a remote monitoring system, when a guardian inputs predetermined authentication data to a master terminal in order to make a request for authentication of the master terminal, the authentication data is transmitted to a firm server via a base station and a cellular phone network. The firm server 15 compares the authentication data with reference data in a registration data file for authentication of the master terminal to execute authentication decision. When the guardian operates keys of a slave operation section 31 to operate the slave terminal remotely from the master terminal, a command signal for causing the slave terminal to perform a desired operation is transmitted form the master terminal to company facilities and temporarily held therein.

### INCORPORATION BY REFERENCE

This application claims priority from Japanese application JP-2003-292780 filed on Aug. 13, 2003, the content of which is hereby incorporated by reference into this application.

### BACKGROUND OF THE INVENTION

This invention relates to a remote monitoring system having mobile master and slave terminals which perform information communication with each other through the medium of a network.

A child confirming and monitoring system has hitherto been proposed which can distribute motion picture image data of children present in a day-care center such as a nursery to individual homes on real time base and can contrive highly efficient use of a network infrastructure and cost reduction therein. In the system, motion picture image data indicative of a state of children transmitted from a control management server is relayed by means of a plurality of routers so as to be distributed to personal computer terminals in individual homes by way of individual routers (see JP-A-2002-026904, for instance).

Apart from the above, a mobile emergency dispatch apparatus has been proposed which can issue an emergency report even in the event that the user per se is not allowed for a report operation and concurrently, can transmit/receive GPS present position information. In the apparatus, when an emergency dispatch box is started by a one-touch-on operation to carry out an emergency countermeasure operation, a cellular phone is operated to automatically call a center and send a report to it and besides, in the event that a user is placed in abnormal condition, a report module is caused to execute a predetermined operation for informing the neighborhood of the user of it (see JP-A-2000-251177, for instance).

In addition, aside from the above, a remote monitoring system based on an inexpensive and easy-to-operate cellular phone has been proposed which can monitor an indoor status from a remote location at any time as necessary by using a cell phone with image display module. In this system, a monitor camera installed in a home is operated remotely by using a control manipulator of the cell phone to pick up the interior of the house and picked-up image information is transmitted from the monitor camera to the cell phone so as to be displayed on the image display module (see JP-A-2001-292442, for instance).

### SUMMARY OF THE INVENTION

Incidentally, ever-increasing participation of women in public affairs has been remarkable in every field and correspondingly, married couples working in double harness have been increasing in number, with the result that the number of mothers who can hardly have time to contact with their children in the daytime representing a time zone of day in which the children are in full activity. In case these children are in institutions, such as for example schools, nursery schools or kindergartens, the children are watched by responsible grown-up persons such as teachers or nurses and they may be substantially in safety.

But when children go out of the institutions or children staying in homes of their own and waiting for the parents coming home go out of doors, they cannot be watched by the parents (guardians) and besides they cannot place themselves under the protection of responsible grown-up people, thus making it very difficult to grasp where the children are and what they do. As a result, there is a fear that children encounter an unexpected accident or they are involved in an incident such as a crime. In addition, at present, aggravated public peace due to increasing violent crimes breeds increased social unrest and the social environment encircling children has been aggravated year by year, so that cases or incidents increase in which children are involved in villainous crimes at places where they cannot be under the protection of guardians such as parents or responsible grown-up's.

Further, in recent years, infants are abused cruelly by their parents who must essentially be their guardians, so that they are injured or, in some case, damaged to death (so-called child or infant abuse). Accordingly, it is considered to be very important in future to reach how to assure safety in daily lives of children who are not watched by guardians and how to protect children from abuse by guardians.

Accordingly, an object of this invention is to provide a remote monitoring system capable of grasping at any time on real time base, conditions at present of a carrier of a slave terminal by way of information communication between the slave terminal and a master terminal even when a carrier of the master terminal is at a location remote from the carrier of the slave terminal.

A slave terminal of this invention being mobile and capable of performing information communication through a network comprises an information acquisition module to automatically acquire information of a kind designated on the basis of a remote control signal from a master terminal, and a transmission module to transmit the information acquired by the information acquisition module to the master terminal on substantially real time base.

A master terminal of this invention being mobile and capable of performing information communication through a network comprises a transmission module to generate a remote control signal and transmit it to a remotely positioned slave terminal, the remote control signal being for commanding the slave terminal to acquire information of a predetermined kind about the neighborhood of the slave terminal and transmit the acquired information of a predetermined kind to the master terminal.

A remote monitoring system of this invention comprises at least one of mobile master and slave terminals capable of performing mutual information communication through a network, the master terminal includes a transmission module to generate a remote control signal and transmit it to the slave terminal at a remote location, the remote control signal being for commanding the slave terminal to acquire information of a predetermined kind about the neighborhood of the slave terminal and transmit the acquired information of a predetermined kind to the master terminal, and the slave terminal includes an information acquisition module to automatically acquire the information of a kind designated on the basis of the remote control signal from the master terminal, and a transmission module to transmit the information acquired by the information acquisition module to the master terminal on substantially real time base.

As described above, according to this invention, the remote monitoring system can be provided in which a carrier of the master terminal can grasp easily conditions of a carrier of the slave terminal positioned remotely from the master terminal and the slave terminal can be controlled easily remotely from the master terminal.

These and other features, objects and advantages of this invention will become more apparent from the following description when taken in conjunction with the accompanying drawings.

### BRIEF DESCRIPTION OF THE DRAWINGS

FIG. 1 is a block diagram showing the overall construction of a remote monitoring system according an embodiment of this invention.

FIG. 2 is a functional block diagram showing the construction of a master terminal provided in the remote monitoring system according to the embodiment of this invention.

FIG. 3 is a functional block diagram showing the construction of a slave terminal provided in the remote monitoring system according to the embodiment of this invention.

FIG. 4 is a diagram for explaining a data file in an authentication control firm server provided in the remote monitoring system according to the embodiment of this invention.

FIG. 5 is a diagram for explaining a data file in an authority organ server provided in the remote monitoring system according to the embodiment of this invention.

FIG. 6 is a process flowchart showing an example of process operation of individual components constituting the remote monitoring system according to the embodiment of this invention.

FIG. 7 is a process flowchart showing another example of process operation of individual components constituting the remote monitoring system according to the embodiment of this invention.

FIG. 8 is a process flowchart showing still another example of process operation of individual components constituting the remote monitoring system according to the embodiment of this invention.

FIG. 9 is a process flowchart showing yet another example of process operation of individual components constituting the remote monitoring system according to the embodiment of this invention.

### DETAILED DESCRIPTION OF THE EMBODIMENTS

The best mode for carrying out this invention will now be described in greater detail with reference to the accompanying drawings.

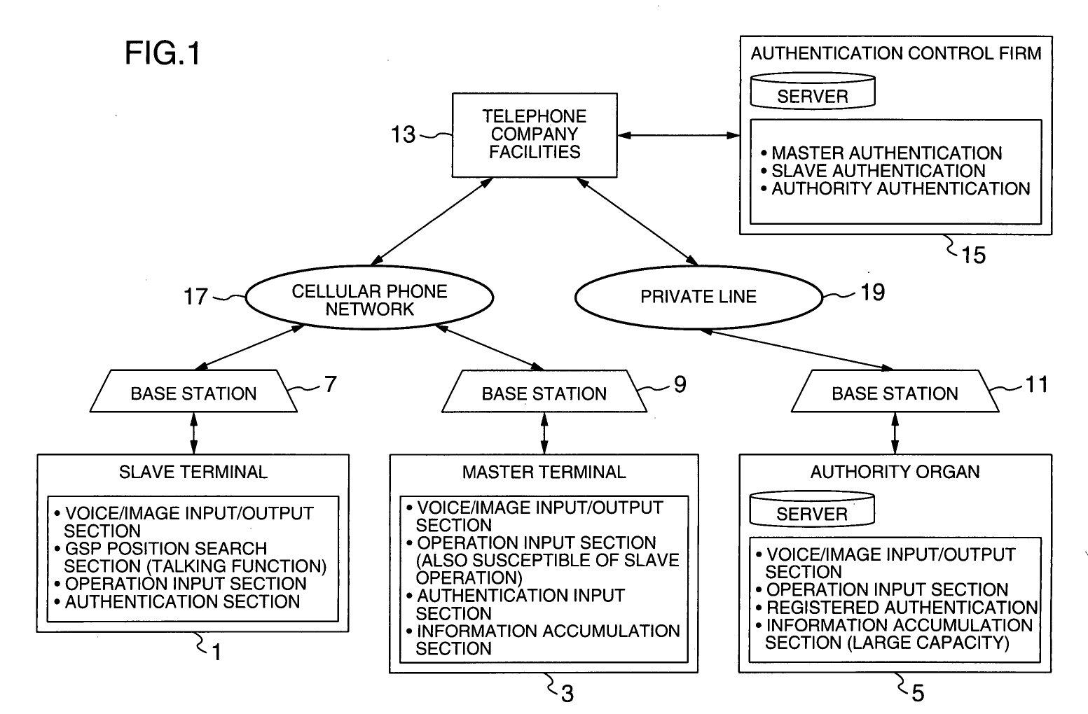

Referring first to FIG. 1, there is illustrated in block diagram form the overall construction of a remote monitoring system according to an embodiment of this invention.

As shown in the figure, the remote monitoring system comprises a slave terminal 1, a master terminal 3, an authority organ server (hereinafter referred to as “organ server”) 5, a plurality of base stations 7, 9 and 11, telephone company facilities (hereinafter referred to as “company facilities”) 13, an authentication control firm server (hereinafter referred to as “firm server”) 15, a cellular phone network 17 and a private line 19.

In this embodiment, cell phones each having at least a pick-up function and an image display function are used as the slave and master terminals 1 and 3 as will be described later. In a practical system, a great number of slave terminals 1 and a great number of master terminals 3 are arranged and the individual master terminals 3 and the individual slave terminals 1 are sorted into a plurality of sets, each of which has one master terminal 3 and at least one or more slave terminals 1 but in this embodiment, for convenience of illustration and explanation, one slave terminal and one master terminal are depicted in FIG. 1.

Further, in the practical system, one service area is divided into a great number of small zones each having a predetermined radius and a base station is installed in each small zone to cover each zone but in this embodiment, for convenience of illustration and explanation, only the three base stations designated by reference numerals 7, 9 and 11 are depicted in FIG. 1.

The slave terminal 1 is of a simplified structure suitable for carriage and operation by a child and it has of course a communication function which is a function inherent in a cell phone and besides includes a voice input/output section, an image input/output section, an operation input section, an authentication input section and a position detection section utilizing, for example, GPS (global positioning system). The voice input/output section is comprised of, for example, a small microphone and a small loudspeaker and the image input/output section corresponds to the aforementioned pick-up function and image display function and is comprised of, for example, a small digital still camera (or small digital video camera) and a small liquid crystal display. The operation input section has a group of keys depressed to operate when a user (child) inputs various kinds of commands to let the slave terminal 1 execute a desired operation. Further, the authentication input section is used when the user of slave terminal 1 (in this embodiment, child) inputs predetermined authentication data (for example, password number data or fingerprint data of the child precedently registered in the firm server 15) to make a request to the firm server 15 for authentication of authorized use of the slave terminal 1.

A normal cell phone is used as the master terminal 3 and like the slave terminal 1, the master terminal 3 has of course a communication function which is a function inherent in the cell phone and besides, it includes a small microphone and a small loudspeaker, for instance, as the voice input/output section, a small digital still camera (or small digital video camera) and a small liquid crystal display, for instance, as the image input/output section and in addition, an operation input section, an authentication input section, a position detection section utilizing the GPS, for instance, and an information accumulation section. The operation input section referred to herein has not only a group of keys depressed to operate when a user represented by a guardian such as mother inputs various kinds of commands to let the master terminal 3 execute a desired operation but also a group of keys necessary to remotely operate the slave terminal 1 so as to cause it to execute a desired operation, for example, turn on/off of a drive power supply of the slave terminal 1. The authentication input section is used when the user of master terminal 3, as represented by a guardian such as mother, inputs predetermined authentication data (for example, a password, fingerprint data of the guardian registered in advance in the aforementioned firm server 15 or a mechanically read result of color discrimination of the guardian's iris) to make a request to the firm server 15 for authentication of authorized use of the master terminal 3. For the purpose of accumulating information of the master terminal 3 per se as well as information transmitted from the slave terminal 1 via the base station 7, cellular phone network 17 and base station 9, the information accumulation section adopts a memory (not shown) having a predetermined storage capacity.

Next, the organ server 5 is installed in an administrative/juridical organ having the right to directly compulsory investigation, such as for example a police station, and it includes a small microphone and a small loudspeaker, for example, as the voice input/output section and a small digital still camera (or small digital video camera) and a small liquid crystal display, for example, as the image input/output section and besides an operation input section and an information accumulation section (not shown) having a far larger capacity than that of the information accumulation section of master terminal 3. The operation input section has a group of keys depressed to operate when a person in charge of the administrative/juridical organ (such as police station) inputs a command for causing the organ server 5 to execute a desired operation. The information accumulation section stores information of the organ server 5 per se as well as information transmitted from the slave terminal 1 and information transmitted from the master terminal 3. Therefore, a memory having a storage area of large capacity is adopted as the information accumulation section of organ server 5. It is now assumed that all pieces of authentication data of the slave terminal 1 and all pieces of authentication data of the master terminal 3 are registered in the information accumulation section. Before the administrative/juridical organ (police station) starts investigation and search for a child carrying the slave terminal 1 by utilizing the organ server 5, a person in charge of the organ server 5 uses the authentication input section to make a request to the firm server 15 for authentication by inputting predetermined authentication data allotted in advance to the organ server 5.

The company facilities 13 include at least a (telephone) office exchange and an office server (or a central management unit of telephone company). The company facilities 13 connect the firm server 15 and the slave terminal 1 via the cellular phone network 17 and base station 7, connect the firm server 15 and the master terminal 3 via the cellular phone network 17 and base station 9 and connect the firm server 15 and the organ server 5 via the private line 19 and base station 11. The company facilities 13 also connect the slave terminal 1 and the organ server 5 via the base station 7, cellular phone network 17, private line 19 and base station 11 and connect the master terminal 3 and the organ server 5 via the base station 9, cellular phone network 17, private line 19 and base station 11. Further, the company facilities 13 connect the slave terminal 1 and the master terminal 3 via the base station 7, cellular phone network 17 and base station 9.

The firm server 15 receives an authentication request transmitted from the slave terminal 1 connected thereto by the action of the company facilities 13 through the medium of the base station 7 and cellular phone network 17 and executes a predetermined authentication process on the basis of the authentication request. Also, the firm server 15 receives an authentication request transmitted from the master terminal 3 connected thereto by the action of the company facilities 13 through the medium of the base station 9 and cellular phone network 17 and executes a predetermined authentication process on the basis of the authentication request. In that case, the firm server 15 also executes a process for confirming that the slave terminal 1 and master terminal 3 are in pairs. The firm server 15 further receives an authentication request transmitted from the organ server 5 connected thereto by the action of the company facilities 13 through the medium of the base station 11 and private line 19 to execute a predetermined authentication process on the basis of the authentication request.

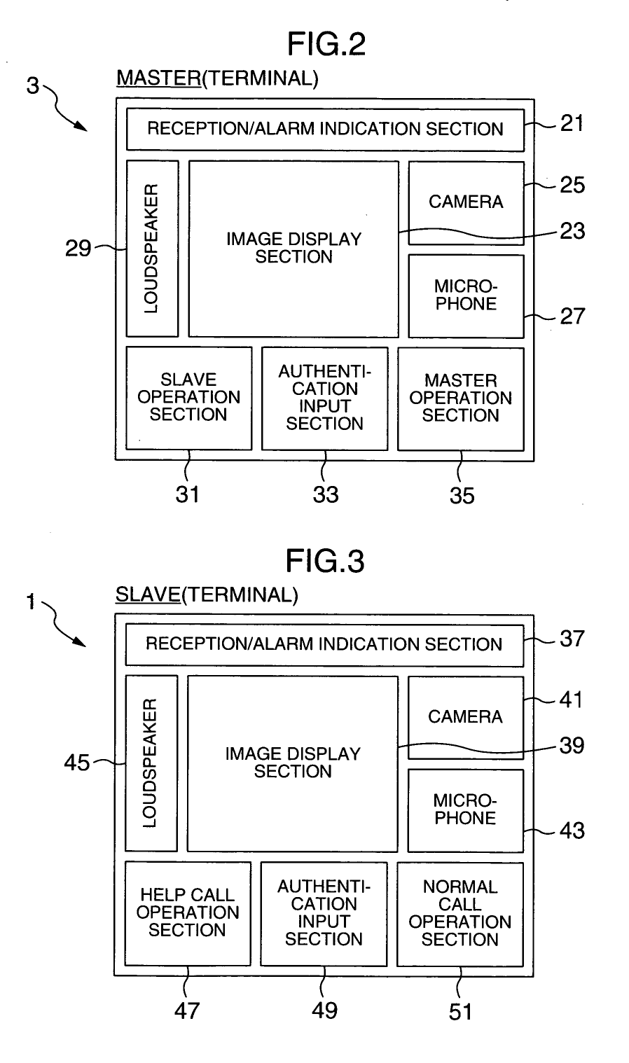

Turning to FIG. 2, the master terminal 3 provided in the remote monitoring system according to the embodiment of this invention is constructed as depicted in functional diagram form.

As shown in the figure, the master terminal 3 includes a reception/alarm indication section 21, an image display section 23, a camera 25, a microphone 27, a loudspeaker 29, a slave terminal operation section (hereinafter referred to as “slave operation section”) 31, an authentication input section 33, and a master terminal operation section (hereinafter referred to as “master operation section”) 35.

For example, when use of the slave terminal 1 is not authenticated (for its authorized use), the reception/alarm indication section 21 indicates, under the control of an operation processing unit such as CPU (not shown) built in the master terminal 3, predetermined alarm information transmitted from the firm server 15 through a communication path of cellular phone network 17 and base station 9 established by the company facilities 13 and information indicative of this position of the slave terminal 1. The alarm information is information indicating that the slave terminal 1 is being used by, for example, a suspicious person. When there is a reception from the company facilities 13 via the cellular phone network 17 and base station 9, the reception/alarm indication section 21 also gives a predetermined reception indication under the control of the operation processing unit (not shown).

The image display section 23 materializes the image display function the master terminal 3 has, corresponding to an image output portion of the image input/output section explained in connection with FIG. 1 and for example, a small liquid crystal display of full color is employed as the section 23. For example, realistic images, images of various icons or images of various characters are displayed in the form of a still picture or motion picture of full color on the image display section 23 by means of the operation processing unit (not shown).

The camera 25 materializes the pick-up function the master terminal 3 has, corresponding to an image input portion of the image input/output section explained in connection with FIG. 1 and for example, a small digital still camera or a small digital video camera is adopted therefor. The camera 25 executes a series of pick-up operations under the control of the operation processing unit (not shown).

The microphone 27 corresponds to a voice input portion of the voice input/output section explained in connection with FIG. 1 and for example, a small microphone of highly directional performance is adopted therefor. The microphone 27 functions as a telephone transmitter under the control of the operation processing unit (not shown) when a user represented by a guardian such as mother gives normal voice talking.

The loudspeaker 29 corresponds to a voice output portion of the voice input/output section explained in connection with FIG. 1 and for example, a small loudspeaker is adopted therefor. The loudspeaker 29 functions as a receiver under the control of the operation processing unit (not shown) when the user represented by a guardian such as mother gives normal voice talking.

The slave operation section 31 is adapted to let the master terminal 3 operate the slave terminal 1 remotely and includes a group of keys depressed to operate so as to deliver a predetermined command signal which causes the slave terminal 1 to execute a desired operation, thus constituting part of the operation input section explained in connection with FIG. 1. A remote operation command signal for slave terminal 1 delivered out of the slave operation section 31 by operating these keys is transmitted, under the control of the operation processing unit (not shown), to the slave terminal 1 connected thereto by the action of the company facilities 13 via the base station 9, cellular phone network 17 and base station 7.

As described with reference to FIG. 1, the authentication input section 33 is used in order for the user of master terminal 3 represented by a guardian such as mother to make a request to the firm server 15 for authentication of authorized use of the master terminal 3 and it includes a group of keys for inputting predetermined authentication data. The authentication data delivered out of the authentication input section 33 when the keys are operated is transmitted to the firm server 15 via the aforementioned communication path under the control of the operation processing unit (not shown).

The master operation section 35 has a group of keys depressed to operate when the user represented by a guardian such as mother inputs a command for causing the master terminal 3 to execute a desired operation under the control of the operation processing unit (not shown) and it cooperates with the slave operation section 31 to constitute part of the operation input section explained in connection with FIG. 1. The master operation section 35 also has a group of keys to be operated when normal talking with, for example, a different master terminal 3 is carried out through the master terminal 3. A normal call signal generated by operating these keys is transmitted, under the control of the operation processing unit (not shown), to the company facilities 13 via the aforementioned communication path, thereby ensuring that the call signal can be transmitted from the company facilities 13 to the different master terminal 3 and the talking with the different master terminal 3 can be done by way of the company facilities 13.

Turning to FIG. 3, the slave terminal 1 provided in the remote monitoring system according to the embodiment of this invention is constructed as depicted in functional block form.

As shown in the figure, the slave terminal 1 includes a reception/alarm indication section 37, an image display section 39, a camera 41, a microphone 43, a loudspeaker 45, a help call operation section 47, an authentication input section 49 and a normal call operation section 51.

The help call operation section 47 has a group of keys to be operated by a child, for example, in order for the child to talk with the master terminal 3 in an emergency as in the case where the child is involved in a criminal incident and in danger. A help call signal generated when these keys are depressed is transmitted to the company facilities 13 via the base station 7 and cellular phone network 17 under the control of an operation processing unit such as CPU (not shown) built in the slave terminal 1. Then, when the use of the master terminal paired with the slave terminal 1 is authenticated by the firm server 15, a call signal is transmitted from the company facilities 13 to the master terminal 3, thus permitting talking between the slave and master terminals 1 and 3 through the company facilities 13.

The normal call operation section 51 has a group of keys to be operated when a user represented by a child carries out normal talking with the master terminal 3 by way of the slave terminal 1. A normal call signal generated when these keys are operated is transmitted, under the control of the aforementioned operation processing unit (not shown), to the company facilities 13 via the aforementioned communication path. Then, when the use of the master terminal 3 paired with the slave terminal 1 is authenticated by the firm server 15 similarly to the above, a call signal is transmitted from the company facilities 13 to the master terminal 3 to thereby permit talking between the slave terminal 1 and the master terminal 3 by way of the company facilities 13.

As described in connection with FIG. 1, the authentication input section 49 is adapted in order for the user of slave terminal 1 represented by a child to make a request to the firm server 15 for authentication of authorized use of the slave terminal 1 and it has a group of keys for inputting predetermined authentication data. The authentication data delivered out of the authentication input section 49 when these keys are operated is transmitted, under the control of the operation processing unit (not shown), to the firm server 15 by way of the aforementioned communication path.

The reception/alarm indication section 37, image display section 39, camera 41, microphone 43 and loudspeaker 45 are constructed identically to the reception/alarm indication section 21, image display section 23, camera 25, microphone 27 and loudspeaker 29 on the side of the master terminal 3, respectively, and they will not be detailed herein.

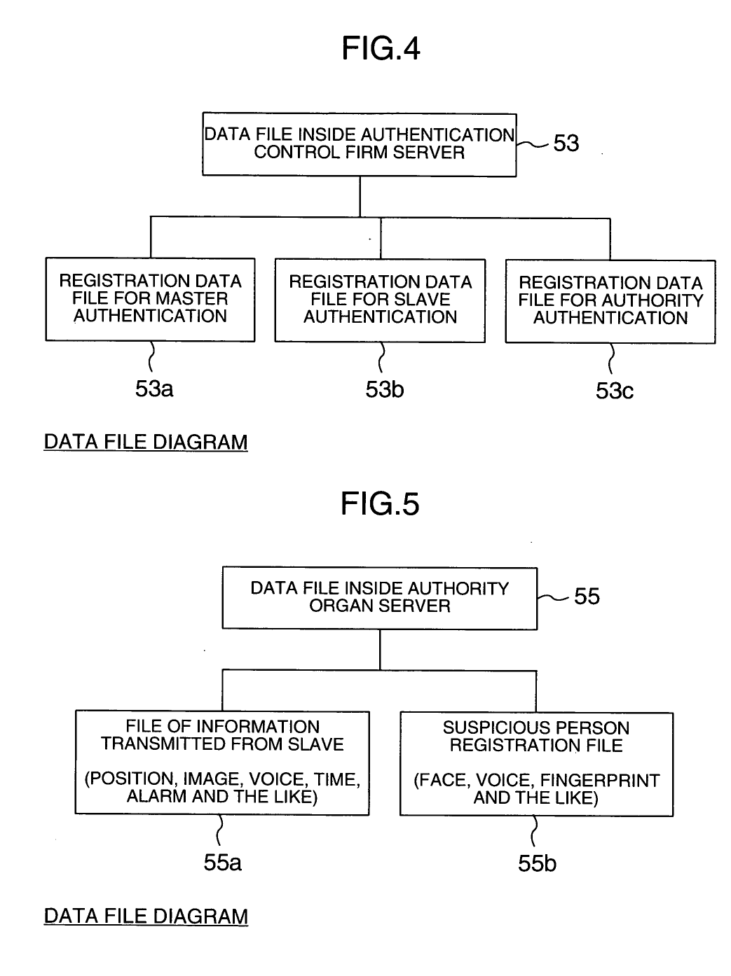

Referring now to FIG. 4, a data file in the (authentication control) firm server 15 provided in the remote monitoring system according to the embodiment of the invention will be explained.

As shown in FIG. 4, a data file 53 in the firm server 15 includes a registration data file 53a for authenticating the use of the master terminal 3, a registration data file 53b for authenticating the use of the slave terminal 1 and a registration data file 53c for authenticating the use of the (authority) organ server 5. In authenticating the use of the master terminal 3, reference data in the registration data file 53a is compared with authentication data transmitted, along with an authentication request, from the master terminal 3 to check whether both the data coincide with each other. In authenticating the user of the slave terminal 1, reference data in the registration data file 53b is compared with authentication data transmitted, along with an authentication request, from the slave terminal 1 to check whether both the data coincide with each other. Further, in authenticating the use of the organ server 5, reference data in the registration data file 53c is compared with authentication data transmitted, along with an authentication request, from the organ server 5 to check whether both the data coincide with each other.

Turning to FIG. 5, a data file in the (authority) organ server 5 provided in the remote monitoring system according to the embodiment of this invention will be explained.

As shown in FIG. 5, a data file 55 in the organ server 5 includes a file 55a of information transmitted from the slave terminal 1 and a suspicious person registration file 55b. The file 55a of information transmitted from the slave terminal 1 contains (the present) position information of the slave terminal 1, image information picking up a scene of the neighborhood of the slave terminal 1, information of a voice uttered by a child representing the user of the slave terminal 1 and of a sound in the neighborhood of the child, information indicative of a transmission time of the above information transmitted from the slave terminal 1, and alarm information for reporting that the child is placed in any abnormal condition. On the other hand, the suspicious person registration file 55b contains information concerning face, voice, fingerprint and the like of a person (suspicious person) apt to do an injury to the child.

When conducting investigation and search in response to a request for search made from a guardian (mother) of the child through the master terminal 3, the organ server 5 uses the aforementioned data file 55 suitably.

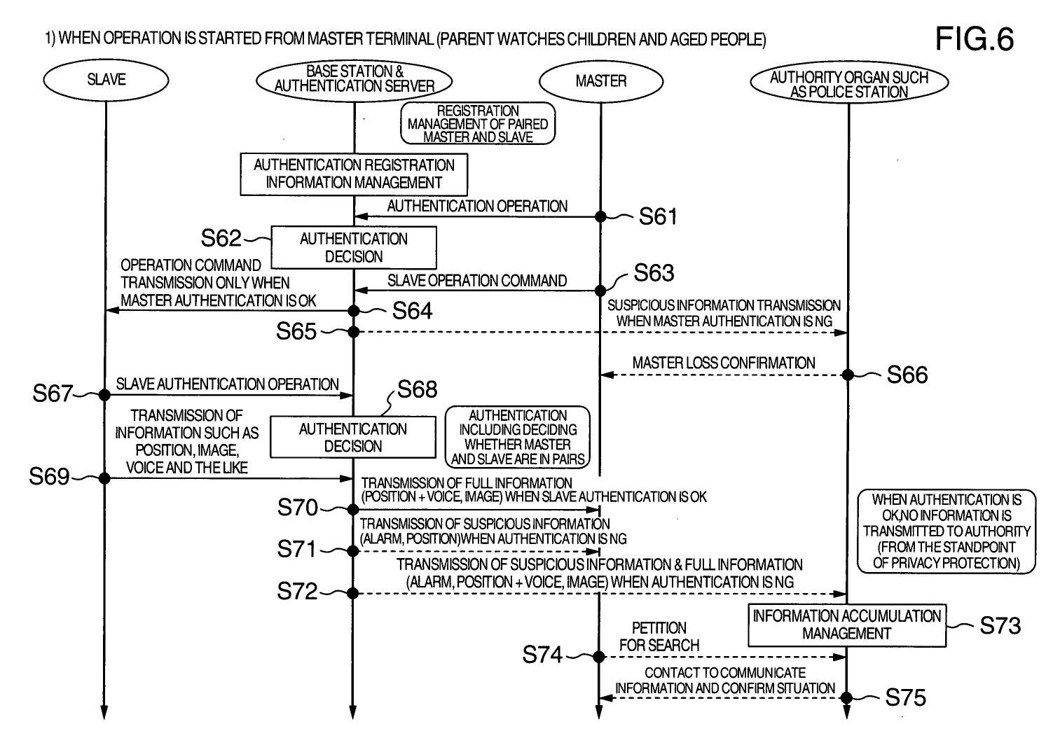

Referring to FIGS. 6, 7, 8 and 9, examples of process operation of individual components constituting the remote monitoring system according to the embodiment of this invention will be described.

Reference is first made to FIG. 6 to describe process procedures when a guardian such as mother monitors a child through the medium of the master terminal 3 and slave terminal 1 by operating the master terminal 3 in the remote monitoring system.

In FIG. 6, when the guardian such as mother first inputs predetermined authentication data to the master terminal 3 by operating the keys of the authentication input section 33 of master terminal 3 (shown in FIG. 2) in order to make a request to the firm server 15 for authentication of authorized use of the master terminal 3, the authentication data is transmitted from the master terminal 3 to the firm server 15 via a communication path of base station 9 and cellular phone network 17 established by means of the company facilities 13 (step S61). When receiving the authentication data, the firm server 15 compares the authentication data with reference data in the registration data file 53a for authentication of the master terminal 3 (shown in FIG. 4) to execute authentication decision by checking whether both the data coincide with each other (step S62). Next, when the guardian such as mother operates the keys of slave operation section 31 to operate the slave terminal 1 remotely from the master terminal 3, a command signal responsive to the operation of the keys and adapted to cause the slave terminal 1 to execute a desired operation is once transmitted from the master terminal 3 to the company facilities 13 via the afore-mentioned communication path and is then held temporarily in the company facilities 13 (step S63).

In case the use of master terminal 3 is authenticated by means of the firm server 15 in the step S62, the aforementioned command signal to the slave terminal 1 is transmitted from the firm server 15 to the slave terminal 1 via a communication path of cellular phone network 17 and base station 7 established by the company facilities 13 (step S64). On the other hand, if the master terminal 3 is determined as being used not by the guardian such as mother but by a suspicious person in the step S62, the authentication data transmitted from the master terminal 3 to the firm server 5 does not coincide with the reference data in the data file 53a. In such an event, the firm server 15 transmits information indicative of the fact that the master terminal 3 is being used without authorization by the suspicious person, that is, suspicious information to the organ server 5 via a communication path of private line 19 and base station 11 set up by the company facilities 13 (step S65). When receiving the suspicious information, the organ server 5 makes an inquiry to the master terminal 3 for the purpose of confirming loss of the master terminal via a communication path of base station 11, private line 19, cellular phone network 17 and base station 9 set up by the company facilities 13 (step S66). In this case, it is of course possible for the organ server 5 to make an inquiry to a normal telephone set (not shown) installed in its own home of the guardian representing the possessor of the master terminal 3 for the purpose of confirming loss of the master terminal, by utilizing a different communication path established by the company facilities 13, that is, a priority group of lines (not shown) for preferentially assuring connection of important talking. In an alternative, the inquiry can be made to a normal telephone set (not shown) installed in an office of the guardian.

Subsequently, when the child inputs predetermined authentication data to the slave terminal 1 by operating the keys of the authentication input section 49 of slave terminal 1 (shown in FIG. 3) to make a request to the firm server 15 for authentication of authorized use of the slave terminal 1, the authentication data is transmitted from the slave terminal 1 to the firm server 15 via a communication path of base station 7 and cellular phone network 17 established by the company facilities 13 (step S67). Receiving the authentication data, the firm server 15 compares it with reference data in the registration data file 53b for authentication of the slave terminal 1 (shown in FIG. 4) to execute authentication decision by checking whether both the data coincide with each other. When the decision result shows that the use of the slave terminal 1 is authenticated, it is checked whether the use of the master terminal 3 paired with the slave terminal 1 is authenticated (step S68). When the use of the slave terminal 1 is not authenticated by the firm server 15 in the step S68, the company facilities 13 respond to a normal call signal from the slave terminal 1 to transmit only a calling signal to the master terminal 3 via the aforementioned communication path.

Subsequently, information including the present position of the slave terminal 1 per se, an image of a neighboring scene picked up by the camera 41 of slave terminal 1 and a voice uttered by the child carrying the slave terminal 1 as well as a sound in the neighborhood is transmitted from the slave terminal 1 to the company facilities 13 via the aforementioned communication path and then the information is temporarily held in the company facilities 13 (step S69). When, in the step S68, the use of the slave terminal 1 is authenticated and besides the use of the master terminal 3 paired with the slave terminal 1 is also authenticated, the company facilities 13 transmit the whole of the information (full information) of position, image and voice from the slave terminal 1, temporarily held in the step S69, to the master terminal 3 via a communication path of cellular phone network 17 and base station 9 established by the company facilities 13 (step S70). Since in this case both the slave terminal 1 and the master terminal 3 paired therewith are authenticated, the company facilities 13 do not transmit the aforementioned information to the organ server 5 from the standpoint of privacy protection.

On the other hand, when the use of the slave terminal 1 is not authenticated (for authorized use) in the step S68, the company facilities 13 transmit, as suspicious information, predetermined alarm information indicative of the fact that the slave terminal 1 is being used by a suspicious person as well as information indicative of the present position of the slave terminal 1 to the master terminal 3 via the aforementioned communication path (step S71). In parallel with the transmission of the suspicious information to the master terminal 3, the company facilities 13 transmit the full information of position, image and voice from the slave terminal 1 temporarily held in the step S69, along with the aforementioned suspicious information, to the organ server 5 via the aforementioned communication path (step S72).

When receiving the suspicious information and the information of position, image and voice from the company facilities 13 via the aforementioned communication path, the organ server 5 accumulates the pieces of information in the database in format as shown in FIG. 5 and manages them (step S73). Thereafter, when a petition for search for the child is transmitted from the guardian such as mother to the organ server 5 via the master terminal 3 and the aforementioned communication path, the organ server 5 receives it (step S74) and then contacts the master terminal 3 to communicate information necessary for conducting a search and confirm the situation (step S75).

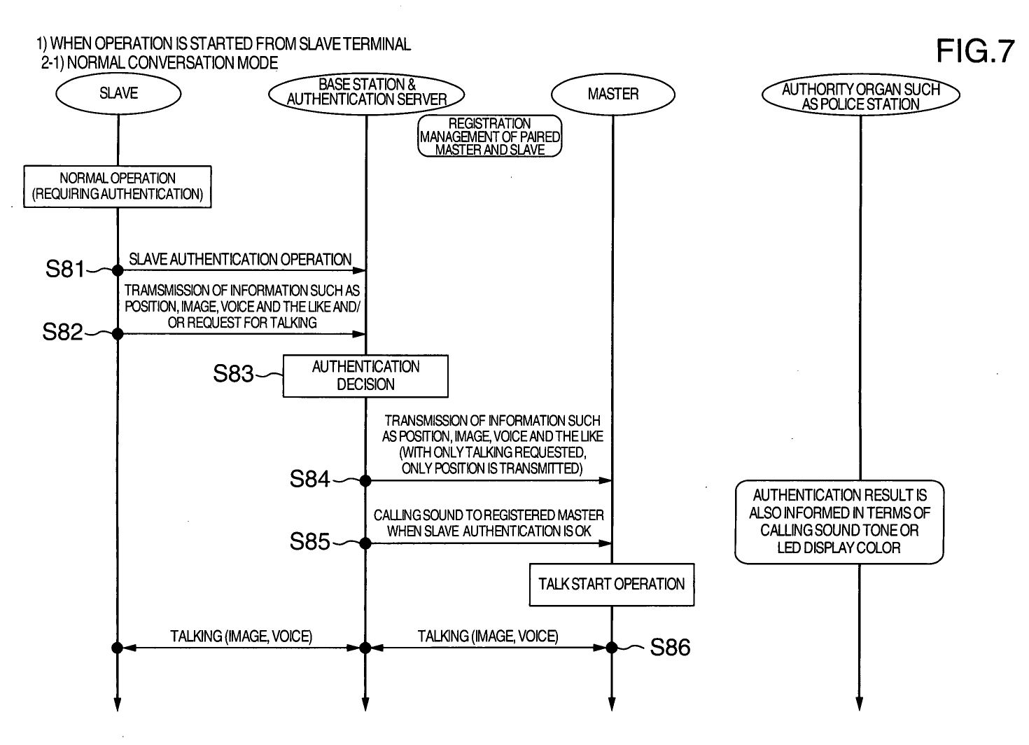

Turning to FIG. 7, there are illustrated process procedures in a normal conversation mode in which a child converses with a guardian such as mother through the slave terminal 1 and master terminal 3 by operating the slave terminal 1 in the remote monitoring system.

In FIG. 7, when the child inputs predetermined authentication data to the slave terminal 1 by operating the keys of the authentication input section 49 of slave terminal 1 (shown in FIG. 3) in order to make a request to the firm server 15 for authentication of authorized use of the slave terminal 1, the authentication data is transmitted from the slave terminal 1 to the firm server 15 via the communication path of base station 7 and cellular phone network 17 established by the company facilities 13 and received by the firm server (step S81). Next, when information of (the present) position, image and voice and/or a request for talking is transmitted from the slave terminal 1 to the company facilities 13 via the aforementioned communication path, the information and/or the talk request is received by the company facilities 13. In case only a request for talking is transmitted from the slave terminal 1 to the company facilities 13, (the present) position information of the slave terminal 1 is also transmitted, together with the talk request (step S82). The firm server 15 compares the aforementioned authentication data from the slave terminal 1 with reference data in the registration data file 53b for authentication of slave terminal 1 (shown in FIG. 4) to execute authentication decision by checking whether both the data coincide with each other (step S83).

When the use of the slave terminal 1 is authenticated by means of the firm server 15 in the step S83, the information of (the present) position, image and voice and/or the talk request from the slave terminal 1 is transmitted from the company facilities 13 to the master terminal 3 via the aforementioned communication path. As described above, when only the talk request is transmitted from the slave terminal 1, only (the present) position information of the slave terminal 1 is transmitted, together with the talk request, from the company facilities 13 to the master terminal 3 via the aforementioned communication path (step S84). Since, in the step S83, the use of the salve terminal 1 is authenticated by means of the firm server 15, the company facilities 13 transmit a calling signal to the master terminal 3 paired with the slave terminal 1 via the aforementioned communication path. In this case, the result of the authentication of slave terminal 1 can be informed to the master terminal 3 by changing the tone of a calling signal sound or the display color, for instance, of an LED (not shown) arranged in the reception/alarm indication section 21 of master terminal 3 (step S85). Even when the use of the slave terminal 1 is not authenticated by means of the firm server 15 in the step S83, the company facilities 13 respond to a normal call signal from the slave terminal 1 to transmit only a calling signal to the master terminal 3 via the afore-mentioned communication path.

Next, by operating the keys of the master operation section 35 (shown in FIG. 2), the guardian such as mother starts talking, accompanied by transmission/reception of image information, on real time base between the master terminal 3 and slave terminal 1 via the communication path of base station 9, cellular phone network 17 and base station 7 established by means of the company facilities 13 (step S86).

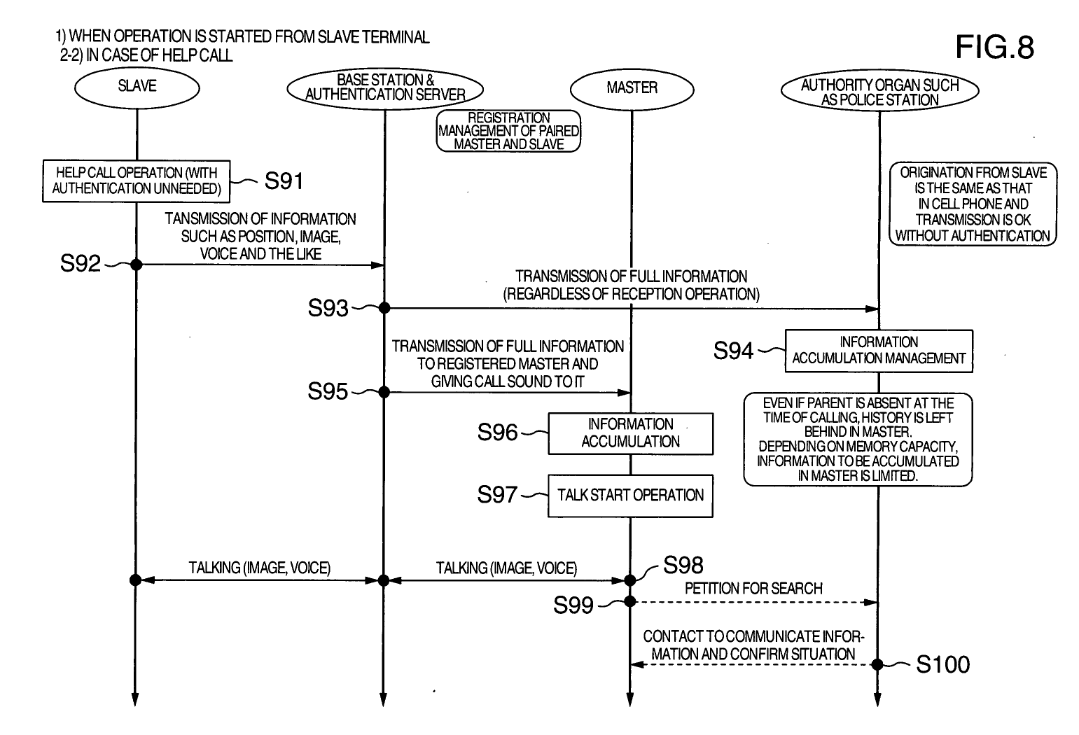

Turning now to FIG. 8, there is illustrated the flow of process operation of the individual components of the system when a child (facing any danger) operates the slave terminal 1 in an emergency to ask for help in the remote monitoring system.

In FIG. 8, when the child operates the help call operation section 47 (shown in FIG. 3), a predetermined help asking signal is transmitted from the slave terminal 1 to the company facilities 13 via the afore-mentioned communication path. In this case, the help asking signal is received by the company facilities 13 without the authentication of use of the slave terminal 1 by means of the firm server 15 (step S91). Subsequently, information such as (the present) position of the slave terminal 1, an image of a scene in the neighborhood of the slave terminal 1 and voice and sound in the neighborhood is transmitted from the slave terminal 1 to the company facilities 13 via the afore-mentioned communication path and then, the company facilities 13 receive the information (step S92) and transmit the full information to the organ server 5 via the afore-mentioned communication path (step S93). When receiving the full information, the organ server 5 accumulates the full information in format as shown at 55a in FIG. 5 and manages it (step S94).

Next, the company facilities 13 transmit a calling sound, together with the full information, to the master terminal 3 paired with the slave terminal 1 via the afore-mentioned communication path (step S95). Receiving the full information, the master terminal 3 accumulates the full information in a built-in memory (not shown) and manages it. The transmission of the information from the company facilities 13 to the master terminal 3 and the accumulation of the information in the memory of master terminal 3 are executed even though the guardian such as mother is absent at the time that the calling signal to the master terminal 3 is transmitted. In case the capacity of the built-in memory of master terminal 3 is small, the kind or the amount of the information to be accumulated in the master terminal 3 is limited as prescribed (step S96).

Next, when the guardian such as mother operates the keys of the master operation section 35 (shown in FIG. 2) (step S97), talking accompanied by transmission/reception of image information is started on real time base via the afore-mentioned communication path between the master and slave terminals 3 and 1 (step S98). A petition for search for the child is subsequently transmitted from the guardian such as mother to the organ server 5 via the master terminal 3 and the afore-mentioned communication path and then, the organ server 5 receives the petition (step S99) and contacts the master terminal 3 via the afore-mentioned communication path to communicate information necessary for conducting a search and confirm the situation (step S100). When, in this case, the organ server 5 calls, for the afore-mentioned communication and confirmation, a normal telephone set (not shown) installed in its own home of the guardian or a normal telephone set (not shown) installed in an office of the guardian by utilizing the afore-mentioned priority group (not shown), secret information such as investigation information can be prevented from leaking to a suspicious person even though an originator of the search petition is not the true guardian of the child but is the suspicious person.

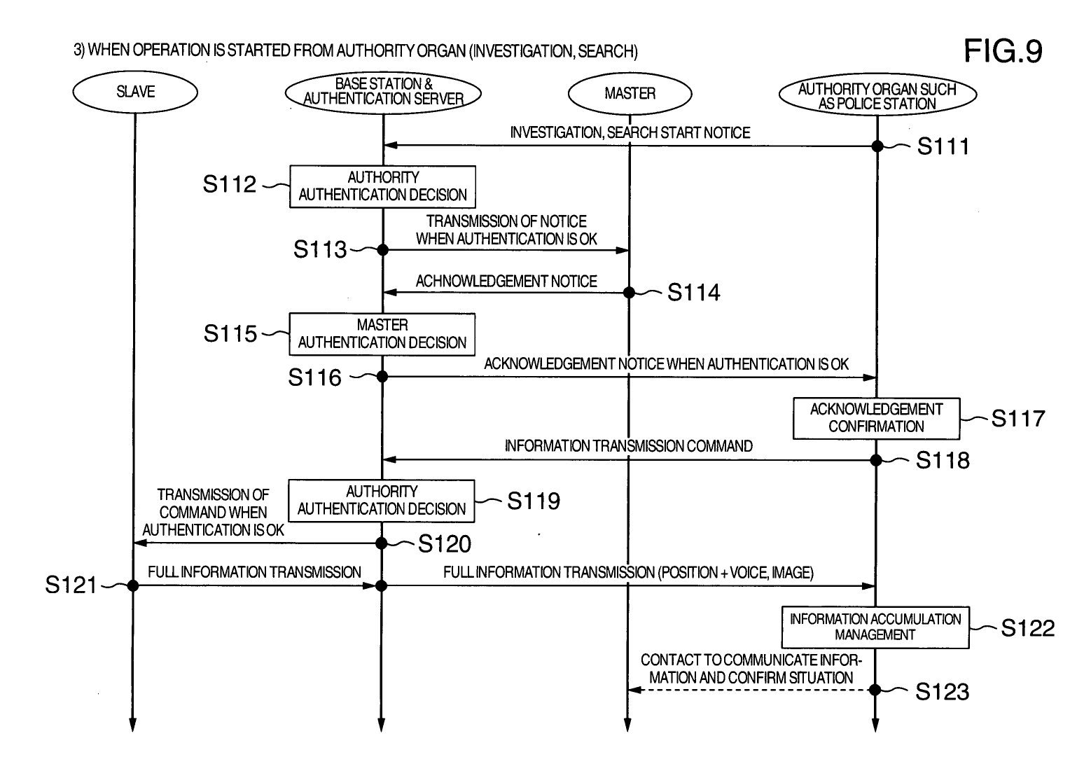

Referring to FIG. 9, there are illustrated process procedures when a person in charge of search organ (such as police station) conducts an investigation (or search) for a child carrying the slave terminal 1 via the company facilities 13 and firm server 15 by operating the organ server 5 in the remote monitoring system.

In FIG. 9, when the person in charge of the organ inputs to the organ server 5 predetermined authentication data by operating the keys of authentication input section of organ server 5 to make a request to the firm server 15 for authentication of use of the organ server 5 and inputs to the organ server 5 a notice to the effect that an investigation (or search) for the child is started by operating the keys of operation input section of the organ server 5, the authentication data and the notice are transmitted from the organ server 5 to the company facilities 13 and firm server 15 via the afore-mentioned communication paths, respectively (step S111). Receiving the authentication data, the firm server 15 compares it with reference data in the registration data file 53c for authentication of organ server 5 (shown in FIG. 4) to execute authentication decision by checking whether both the data coincide with each other (step S112).

When the use of the organ server 5 is authorized by the firm server 15 in the step S112, a report to the effect that the notice purporting that an investigation (or search) for the child carrying the slave terminal 1 is started is received from the organ server 5 is subsequently transmitted from the company facilities 13 to the master terminal 3 via the aforementioned communication path (step S113). With the report received by the master terminal 3, the guardian such as mother operates the master operation section 35 (of master terminal 3 shown in FIG. 2) so that a notice to the effect that the afore-mentioned report is acknowledged may be issued from the master terminal 3 and the notice is transmitted to the company facilities 13 via the communication path. At that time, for the purpose of making a request for authentication of the use of the master terminal 3, predetermined authentication data is also transmitted from the master terminal 3 to the firm server 15 via the aforementioned communication path (step S114).

When the use of the master terminal 3 is authenticated by means of the firm server 15 on the basis of the authentication data (step S115), the notice from the master terminal 3 (guardian such as mother) to the effect that start of an investigation (or search) for the child carrying the slave terminal 1 by the search organ (such as a police station) is acknowledged is transmitted from the company facilities 13 to the organ server 5 via the afore-mentioned communication path (step S116). Receiving this notice, the organ server 5 confirms the afore-mentioned acknowledgement (step S117) and besides commands, through the afore-mentioned communication path, the company facilities 13 to transmit the full information transmitted from the slave terminal 1 to the organ server 5 and again transmits the predetermined authentication data to the firm server 15 (step S118).

Receiving the command and the authentication data from the organ server 5, the firm server 15 again decides whether the use of the organ server 5 is to be authenticated and then authenticates it (step S119) and thereafter, the company facilities 13 transmit to the slave terminal 1, via the afore-mentioned communication path, a command for causing it to transmit the full information (position, image and voice) obtainable by the slave terminal 1 to the company facilities 13 (step S120). Receiving the command, the slave terminal 1 transmits the full information of (the present) position of slave terminal 1, image of a scene of the neighborhood of the slave terminal 1 and voice and sound in the neighborhood to the company facilities 13 via the afore-mentioned communication path. Receiving the full information, the company facilities 13 transmit it to the organ server 5 via the aforementioned communication path (step S121).

When receiving the full information, the organ server 5 accumulates and manage the full information in format as shown at 55a in FIG. 5 (step S122) and contacts the master terminal 3 via the aforementioned communication path to communicate information necessary for conducting the search and confirm the situation (step S123).

As described above, according to the embodiment of the invention, even when a guardian carrying the master terminal 3 is at a position remote from a child carrying the slave terminal 1, the present conditions of the child can be grasped as desired on real time base by way of information communication between the slave and master terminals 1 and 3.

Further, according to the embodiment of this invention, in the remote monitoring system comprising the mobile master and slave terminals 3 and 1, the slave terminal 1 carried by a child at a position remote from a guardian can be prevented from being used without authorization or misused by a third party. More particularly, according to the embodiment of this invention, provided that the use of both the slave and master terminals 1 and 3 is authenticated by the firm server 15, transmission of information from the slave terminal 1 to the master terminal 3 is permitted, thereby ensuring that even when a suspicious person obtains the slave and master terminals 1 and 3, sets the slave terminal 1 secretly at a desired location and operates the slave terminal 1 remotely from the master terminal 3 to perform peeping and tapping, the suspicious person cannot acquire by way of the master terminal 3 information the slave terminal 1 has obtained through peeping and tapping and as a result the illegal use of the system can be suppressed.

Further, according to the embodiment of this invention, even when a guardian carrying the master terminal 3 is at a position remote from a child carrying the slave terminal 1, the slave terminal 1 can be operated remotely from the master terminal 3 by way of information communication between the slave and master terminals 1 and 3. For example, when the guardian such as mother operates the slave terminal 1 remotely by way of the master terminal 3 and recognizes from image information and voice information transmitted from the slave terminal 1 that the child is about to be attacked by a criminal, such a message (talk) to the child as “What has happened ? ”, a predetermined alarm sound or a sound to threaten the criminal can be delivered out of the loudspeaker of the slave terminal 1 through the remote operation and a kind of the crime prevention effect such as making the criminal shrink back can be expected.

In addition, according to the embodiment of this invention, in the remote monitoring system comprising the mobile master and slave terminals 3 and 1, when the authentication is made to be disabled owing to the fact that the master terminal 3 and/or the slave terminal 1 is not used by an authorized user, information concerning the master terminal 3 and/or slave terminal 1 can be verified later. In other words, even in the event that a suspicious person obtains the slave terminal 1 and uses it without authorization and consequently authorized use is not authenticated, various kinds of information from the slave terminal 1 are transferred to the organ server 5 and accumulated therein, thereby ensuring that when an incident takes place by any chance (in case of so-called emergency), the authority organ can make full use of the afore-mentioned information to quickly undertake investigation and search for a child.

While, in the foregoing, preferred embodiments of this invention have been described, these are merely illustrative of this invention and the scope of this invention is in no way limited by the embodiments. This invention can be carried out in other various modes.

For example, in the foregoing embodiments, the (authority) organ has been described as being exemplified by a police station but the (authority organ) is not always limited to only the police station and it may be a guard company or a private company such as a telephone company. Further, in the foregoing embodiments, the (authentication control) firm server 15 has been described as authenticating the use of the slave terminal 1, master terminal 3 and organ server 5 but aside from the (authentication control) firm server 15, an information server or business server (communication server) of a telephone company (or a central management unit of a telephone company) may participate in authenticating the use of the slave terminal 1, master terminal 3 and organ terminal 5. To add, to assure sufficient security, the afore-mentioned information server or business server may be placed under the management of the (authority) organ.

The term of validity of the authentication of the slave terminal 1 and master terminal 3 by means of the firm server 15 can be set freely to, for example, within one month from authentication date or within a period of each communication.

Further, a solar battery or a fuel cell may be used as a drive power supply of the slave terminal 1 and normally the power supply may be in power saving mode but when a child is placed in any abnormal condition, this incident may be detected with a suitable sensor to start the slave terminal 1.

This invention can be applied to a monitoring system in which for example, a guardian such as mother at a remote location can grasp accurately on real time base actions of a schoolchild or younger child and a situation in which the child is placed and can take suitable countermeasures if the child encounters danger and accident.

While we have shown and described several embodiments in accordance with this invention, it should be understood that the disclosed embodiments are susceptible of changes and modifications without departing from the scope of this invention. Therefore, we do not intend to be bound by the details shown and described herein but intend to cover all such changes and modifications falling within the ambit of the appended claims.

1. A slave terminal which is mobile and performs information communication through a network, comprising:
an information acquisition module which automatically acquires information of a kind designated on the basis of a remote control signal from a master terminal; and
a transmission module which transmits the information acquired by said information acquisition module to the master terminal on substantially real time base.

2. A slave terminal according to claim 1, wherein the automatic acquisition of the information of the designated kind includes a pick-up operation and/or sound collection operation and/or detection operation of the present position.

3. A master terminal which is mobile and performs information communication through a network, comprising:
a transmission module which generates a remote control signal and transmit it to a slave terminal at a remote location, the remote control signal being for commanding the slave terminal to acquire information of a predetermined kind in the neighborhood of the slave terminal and transmit the acquired information of the predetermined kind to said master terminal.

4. A master terminal according to claim 3, wherein said transmission module transmits, in place of or in addition to the remote control signal, sound information concerning an uttered voice of a message or an alarm sound to the slave terminal.

5. A remote monitoring system comprising at least one of mobile master and slave terminals which perform information communication with each other through a network, wherein
said master terminal includes a transmission module to generate a remote control signal and transmit it to said slave terminal at a remote location, the remote control signal being for commanding said slave terminal to acquire information of a predetermined kind in the neighborhood of said slave terminal and transmit the acquired information of the predetermined kind to said master terminal; and
said slave terminal includes:
an information acquisition module to automatically acquire the information of the kind designated on the basis of the remote control signal from said master terminal; and
a transmission module to transmit the information acquired by the information acquisition module to said master terminal on substantially real time base.

6. A remote monitoring system according to claim 5, wherein the acquisition of the information of the predetermined kind includes a pick-up operation and/or sound collection operation and/or detection operation of the present position.

7. A remote monitoring system comprising at least one of mobile master and slave terminals which perform information communication with each other through a network, wherein
said master terminal includes a transmission module to transmit sound information concerning an uttered voice of a message or an alarm sound to said slave terminal at a remote location; and
said slave terminal includes a sound output module to automatically deliver a sound on the basis of the sound information concerning an uttered voice of a message or an alarm sound from said master terminal.

8. A remote monitoring system according to claim 5, wherein said slave terminal further includes a drive power supply control module to on/off control a drive power supply of said slave terminal only when an event requiring start of said slave terminal occurs.

9. A remote monitoring system according to claim 5, wherein said slave terminal further includes an accident informing module to detect an accident and inform said master terminal of the accident when the accident takes place for some reason in connection with a carrier of said slave terminal.

10. A remote monitoring system according to claim 5, wherein said master terminal further includes a module to control said slave terminal so as to cause it to perform a predetermined report operation for reporting an emergency by transmitting predetermined sound information to said slave terminal.

11. A remote monitoring system according to claim 5 further comprising an information management server performing information communication with said master and slave terminals through the network.

12. A remote monitoring system according to claim 5 further comprising an authentication server performing information communication with said master terminal, slave terminal and information management server through the network and adapted to conduct a process for authentication of said master terminal, slave terminal and information management server.

13. A remote monitoring system according to claim 5, wherein when the authentication of said slave terminal by said authentication server is unsuccessful, information transmission from said slave terminal to said master terminal is suppressed.

14. A remote monitoring system according to claim 5, wherein when the authentication of said slave terminal by said authentication server is unsuccessful, alarm information indicative of the unsuccessfulness of authentication of slave terminal is transmitted from said slave terminal to said master terminal.

15. A remote monitoring system according to claim 5, wherein
said slave terminal further includes an authentication request module to request authentication of said slave terminal by said authentication server; and
said authentication request module includes an operation input module to make a decision on the basis of an operation procedure such as password number data input of a carrier of said slave terminal or a module to input living body information of a possessor such as fingerprint data of the carrier of said slave terminal registered in advance in said authentication server.

16. A remote monitoring system according to claim 5, wherein when the authentication of said slave terminal by said authentication server is unsuccessful, said information management server determines that the carrier of said slave terminal is a suspicious person.

17. A remote monitoring system according to claim 5, wherein when the authentication of said master terminal by said authentication server is unsuccessful, said information management server determines that the carrier of said master terminal is a suspicious person.

18. A remote monitoring system according to claim 5, wherein when the authentication of said slave terminal and/or master terminal by said authentication server is unsuccessful, said information management server accumulates information transmitted from a terminal for which said authentication is unsuccessful.

19. A remote monitoring system according to claim 5, wherein when the authentication of said slave and master terminals by said authentication server is successful, the information to be transmitted from said slave terminal to said master terminal is prevented from being transmitted to said information management server.

20. A remote monitoring system according to claim 5, wherein said information management server collects the information from said slave terminal after obtaining a consent notice from said master terminal.
